(19) United States
(12) Patent Application Publication
(10) Pub. No.: US 2017/0315928 A1
(43) Pub. Date: Nov. 2, 2017

(54) COARSE-GRAINED CACHE REPLACEMENT SCHEME FOR A CLOUD-BACKED DEDUPLICATION STORAGE SYSTEM

(71) Applicant: NetApp, Inc., Sunnyvale, CA (US)

(72) Inventors: Vinay Hangud, Saratoga, CA (US); Sharad Jain, Santa Clara, CA (US); Sudhindra Prasad Tirupati Nagaraj, Sunnyvale, CA (US)

(21) Appl. No.: 15/141,423

(22) Filed: Apr. 28, 2016

(51) Int. Cl. G06F 12/12; G06F 12/0891

(52) U.S. Cl. CPC G06F 12/12; G06F 12/0891; G06F 2212/60

(57) ABSTRACT

Exemplary embodiments relate to cache replacement schemes. Incoming data may be sorted into buckets. When it comes time to replace information in the cache, an entire bucket may be eliminated or replaced at once. By sorting incoming data into the buckets and performing cache replacement on a bucket-by-bucket basis, cache fragmentation is reduced. Moreover, the buckets may be scored based on characteristics of the data in the buckets (e.g., whether a data item is cold archived, whether a customer has pinned the data item, or whether the customer has requested early eviction of the data item). By accounting for these metrics when the cache score is calculated, cache usage and hit rates may be improved. According to exemplary embodiments, scoring may be applied to entire buckets, or may be applied to individual cache items (e.g., for use as a cache replacement metric in a cache eviction scheme).

### BACKGROUND

In order to improve efficiency or memory access, computing systems may rely on a cache which places frequently- or recently-used data in an easily accessible location. When the system needs access to the data, it may read the data from the relatively fast or efficient cache, instead of requesting the data from the slower or less efficient main storage.

Caches have limited size, and therefore can become full over time. When the system needs to add new items to the cache, but there is no room remaining in the cache, the system must select existing cached items for replacement.

Cache replacement algorithms select data items in the cache for replacement. For example, if the cache employs the “least recently used” (LRU) cache replacement algorithm, the system selects the item in the cache whose most recent use is the farthest in the past. This item is evicted in favor of a new data item. Other schemes used for cache replacement include most recently used (MRU), random replacement, Belady's Replacement, etc.

### BRIEF DESCRIPTION OF THE DRAWINGS

FIG. 1A depicts an exemplary cluster hosting virtual machines.

FIG. 1B depicts an exemplary environment suitable for use with embodiments described herein.

FIG. 2A depicts a cache suitable for use with exemplary embodiments.

FIG. 2B depicts the cache of FIG. 2A divided into buckets.

FIGS. 3A-3B depicts an exemplary bucketed cache in which the buckets are associated with bucket scores.

FIG. 4 depicts an exemplary non-bucketed cache in which cache blocks are associated with block scores.

FIG. 5 is a flowchart describing an exemplary method for maintaining a bucketed cache.

FIG. 6 is a flowchart describing an exemplary method for scoring blocks and/or buckets in a cache.

FIG. 7 depicts exemplary computing logic suitable for carrying out the method depicted in FIGS. 5-6.

FIG. 8 depicts an exemplary computing device suitable for use with exemplary embodiments.

FIG. 9 depicts an exemplary network environment suitable for use with exemplary embodiments.

### DETAILED DESCRIPTION

Traditional approaches to cache replacement leave room for improvement. For example, traditional cache replacement decisions are made at the level of individual data items. As items are removed from various locations in the cache, the free space in the cache is fragmented into relatively small chunks. As a result, it may not be possible to insert an entire data item into the cache in a contiguous storage area; the data item may need to be broken into pieces that are distributed throughout the cache. This may lead to sub-optimal cache utilization. Moreover, some caches attempt to store related data together (a principle known as locality), under the assumption that if a request is received for some data, a request for related data is likely to occur in the near future. Fragmentation of the cache due to replacement on an item-by-item basis can reduce or eliminate locality and cause poor cache input/output (I/O) performance.

Furthermore, when a traditional cache is used to cache data items from a cloud storage, the cache replacement scheme typically does not account for cloud-specific data characteristics such as whether the data has been placed into cold storage (i.e., placed into cloud storage that is optimized for infrequent access) and whether the data has recently been deduplicated (where an extra copy of data that resides in multiple locations in the cloud is removed). This can result in inefficient caching, poor deduplication, and high cloud costs.

Exemplary embodiments described below relate to cache replacement schemes. According to some embodiments, data coming into a cache is sorted to buckets. When it comes time to replace information in the cache, an entire bucket may be eliminated at once. By replacing whole buckets, rather than replacing cached items individually, cache fragmentation may be reduced.

The data items and/or the buckets may be scored based on data characteristics. The characteristics may include fixed characteristics, which are fixed at the time the data item is admitted to the cache, and variable characteristics, which may change while the data item is resident in the cache. Different scores may be calculated for a data item's fixed and variable characteristics, and a block score may be calculated based on the fixed and variable scores. If buckets are being used, a bucket score may be calculated based on the block scores of the data items in the bucket. The bucket scores may be used to rank the buckets, and the bucket with the lowest score may be selected as the next bucket to evict.

The sorting of data blocks into buckets and the scoring of the data blocks and/or buckets may be used separately or together. Thus, data items may be sorted into buckets and an entire bucket could be replaced without scoring the data items or the buckets. Alternatively, individual data items may be scored without sorting the data items into buckets, and the data items may be replaced in the cache based on their respective scores. Still further, data items may be sorted into buckets and scored, and entire buckets may be replaced based on the bucket scores.

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a,” “b,” etc. (and similar designators) are intended to be variables representing any positive integer. Thus, for example, if an implementation sets a value for a=5, then a complete set of components 122 illustrated as components 122-1 through 122-a may include components 122-1, 122-2, 122-3, . . . , 122-a. The embodiments are not limited in this context.

### Overview of a Data Storage System

Before describing the exemplary block allocation techniques in detail, an exemplary environment in which the techniques may be employed is first described. It is noted however, that this description is for illustrative purposes only, and that the present invention is not limited to the environment discussed below but may be employed with a cache in any suitable environment.

In general, exemplary embodiments may be employed in any system in which data storage is allocated in blocks. For example, a personal computer may include a hard drive on which data is stored, and the available storage space on the hard drive may be allocated according to the block allocation technique described herein. Because it is expected that one of ordinary skill in the art will be familiar with such a system, a detailed overview is omitted for the sake of brevity.

In addition to application on a personal computing system, exemplary embodiments may be particularly well-suited to managing block allocation in a shared or clustered storage environment. Such systems tend to see a higher volume to write operations and block allocation requests, allowing for better and more accurate block size calculations.

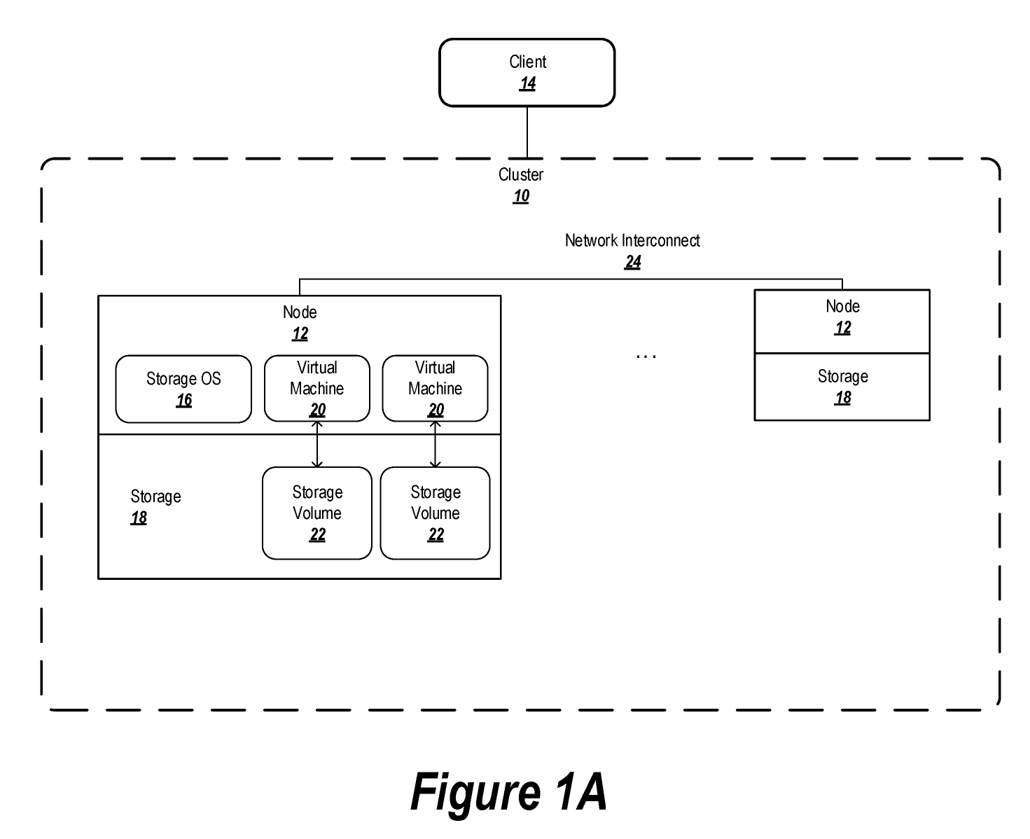

FIGS. 1A and 1B depict an example of a clustered storage environment in which the exemplary block allocation techniques may be employed.

FIG. 1A depicts an example of a cluster 10 suitable for use with exemplary embodiments. A cluster 10 represents a collection of one or more nodes 12 that perform services, such as data storage or processing, on behalf of one or more clients 14.

In some embodiments, the nodes 12 may be special-purpose controllers, such as fabric-attached storage (FAS) controllers, optimized to run a storage operating system 16 and manage one or more attached storage devices 18. The nodes 12 provide network ports that clients 14 may use to access the storage 18. The storage 18 may include one or more drive bays for hard disk drives (HDDs), flash storage, a combination of HDDs and flash storage, and other non-transitory computer-readable storage mediums.

The storage operating system 16 may be an operating system configured to receive requests to read and/or write data to one of the storage devices 18 of the cluster 10, to perform load balancing and assign the data to a particular storage device 18, and to perform read and/or write operations (among other capabilities). The storage operating system 16 serves as the basis for virtualized shared storage infrastructures, and may allow for nondisruptive operations, storage and operational efficiency, and scalability over the lifetime of the system. One example of a storage operating system 16 is the Clustered Data ONTAP® operating system of NetApp, Inc. of Sunnyvale, Calif.

The nodes 12 may be connected to each other using a network interconnect 24. One example of a network interconnect 24 is a dedicated, redundant 10-gigabit Ethernet interconnect. The interconnect 24 allows the nodes 12 to act as a single entity in the form of the cluster 10.

A cluster 10 provides hardware resources, but clients 14 may access the storage 18 in the cluster 10 through one or more storage virtual machines (SVMs) 20. SVMs 20 may exist natively inside the cluster 10. The SVMs 20 define the storage available to the clients 14. SVMs 20 define authentication, network access to the storage in the form of logical interfaces (LIFs), and the storage itself in the form of storage area network (SAN) logical unit numbers (LUNs) or network attached storage (NAS) volumes.

SVMs 20 store data for clients 14 in flexible storage volumes 22. Storage volumes 22 are logical containers that contain data used by applications, which can include NAS data or SAN LUNs. The different storage volumes 22 may represent distinct physical drives (e.g., different HDDs) and/or may represent portions of physical drives, such that more than one SVM 20 may share space on a single physical drive.

Clients 14 may be aware of SVMs 20, but they may be unaware of the underlying cluster 10. The cluster 10 provides the physical resources the SVMs 20 need in order to serve data. The clients 14 connect to an SVM 20, rather than to a physical storage array in the storage 18. For example, clients 14 require IP addresses, World Wide Port Names (WWPNs), NAS volumes, SMB (CIFS) shares, NFS exports, and LUNs. SVMs 20 define these client-facing entities, and use the hardware of the cluster 10 to deliver the storage services. An SVM 20 is what users connect to when they access data.

Connectivity to SVMs 20 is provided through logical interfaces (LIFs). A LIF has an IP address or World Wide Port Name used by a client or host to connect to an SVM 20. A LIF is hosted on a physical port. An SVM 20 can have LIFs on any cluster node 12. Clients 14 can access data regardless of the physical location of the data in the cluster 10. The cluster 10 will use its interconnect 24 to route traffic to the appropriate location regardless of where the request arrives. LIFs virtualize IP addresses or WWPNs, rather than permanently mapping IP addresses and WWPNs to NIC and HBA ports. Each SVM 20 may use its own dedicated set of LIFs.

Thus, like compute virtual machines, SVMs 20 decouple services from hardware. Unlike compute virtual machines, a single SVM 20 can use the network ports and storage of many nodes 12, enabling scale-out. One node's 12 physical network ports and physical storage 18 also can be shared by many SVMs 20, enabling multi-tenancy.

A single cluster 10 can contain multiple SVMs 20 targeted for various use cases, including server and desktop virtualization, large NAS content repositories, general-purpose file services, and enterprise applications. SVMs 20 can also be used to separate different organizational departments or tenants. The components of an SVM 20 are not permanently tied to any specific piece of hardware in the cluster 10. An SVM's volumes 22, LUNs, and logical interfaces can move to different physical locations inside the cluster 10 while maintaining the same logical location to clients 14. While physical storage and network access moves to a new location inside the cluster 10, clients 14 can continue accessing data in those volumes or LUNs, using those logical interfaces.

This capability allows a cluster 10 to continue serving data as physical nodes 12 are added or removed from the cluster 10. It also enables workload rebalancing and native, nondisruptive migration of storage services to different media types, such as flash, spinning media, or hybrid configurations. The separation of physical hardware from storage services allows storage services to continue as all the physical components of a cluster are incrementally replaced. Each SVM 20 can have its own authentication, its own storage, its own network segments, its own users, and its own administrators. A single SVM 20 can use storage 18 or network connectivity on any cluster node 12, enabling scale-out. New SVMs 20 can be provisioned on demand, without deploying additional hardware.

One capability that may be provided by a storage OS 16 is storage volume snapshotting. When a snapshot copy of a volume 22 is taken, a read-only copy of the data in the volume 22 at that point in time is created. That means that application administrators can restore LUNs using the snapshot copy, and end users can restore their own files.

Snapshot copies are high-performance copies. When writes are made to a flexible volume 22 that has an older snapshot copy, the new writes are made to free space on the underlying storage 18. This means that the old contents do not have to be moved to a new location. The old contents stay in place, which means the system continues to perform quickly, even if there are many Snapshot copies on the system. Volumes 22 can thus be mirrored, archived, or nondisruptively moved to other aggregates.

Therefore, snapshotting allows clients 14 to continue accessing data as that data is moved to other cluster nodes. A cluster 10 may to continue serving data as physical nodes 12 are added or removed from it. It also enables workload rebalancing and nondisruptive migration of storage services to different media types. No matter where a volume 22 goes, it keeps its identity. That means that its snapshot copies, its replication relationships, its deduplication, and other characteristics of the flexible volume remain the same.

The storage operating system 16 may utilize hypervisor-agnostic or hypervisor-independent formatting, destination paths, and configuration options for storing data objects in the storage devices 18. For example, Clustered Data ONTAP® uses the NetApp WAFL® (Write Anywhere File Layout) system, which delivers storage and operational efficiency technologies such as fast, storage-efficient copies; thin provisioning; volume, LUN, and file cloning; deduplication; and compression. WAFL® accelerates write operations using nonvolitile memory inside the storage controller, in conjunction with optimized file layout on the underlying storage media. Clustered Data ONTAP® offers integration with hypervisors such as VMware ESX® and Microsoft® Hyper-V®. Most of the same features are available regardless of the protocol in use.

Although the data objects stored in each VM's storage volume 22 may be exposed to the client 14 according to hypervisor-specific formatting and path settings, the underlying data may be represented according to the storage operating system's hypervisor-agnostic configuration.

Management of the cluster 10 is often performed through a management network. Cluster management traffic can be placed on a separate physical network to provide increased security. Together, the nodes 12 in the cluster 10, their client-facing network ports (which can reside in different network segments), and their attached storage 18 form a single resource pool.

FIG. 1B shows the configuration of the SVMs 20 in more detail. A client 14 may be provided with access to one or more VMs 20 through a node 12, which may be a server. Typically, a guest operating system (distinct from the storage OS 18) runs in a VM 20 on top of an execution environment platform 26, which abstracts a hardware platform from the perspective of the guest OS. The abstraction of the hardware platform, and the providing of the virtual machine 20, is performed by a hypervisor 28, also known as a virtual machine monitor, which runs as a piece of software on a host OS. The host OS typically runs on an actual hardware platform, though multiple tiers of abstraction may be possible. While the actions of the guest OS are performed using the actual hardware platform, access to this platform is mediated by the hypervisor 28.

For instance, virtual network interfaces may be presented to the guest OS that present the actual network interfaces of the base hardware platform through an intermediary software layer. The processes of the guest OS and its guest applications may execute their code directly on the processors of the base hardware platform, but under the management of the hypervisor 28.

Data used by the VMs 20 may be stored in the storage system 18. The storage system 18 may be on the same local hardware as the VMs 20, or may be remote from the VMs 20. The hypervisor 28 may manage the storage and retrieval of data from the data storage system 18 on behalf of the VMs 20. Different types of VMs 20 may be associated with different hypervisors 28. Each type of hypervisor 28 may store and retrieve data using a hypervisor-specific style or format.

Next, exemplary cache replacement techniques for managing a cache in one or more devices in the clustered storage environment (or any other suitable type of environment) is described.

### Cache Bucketing

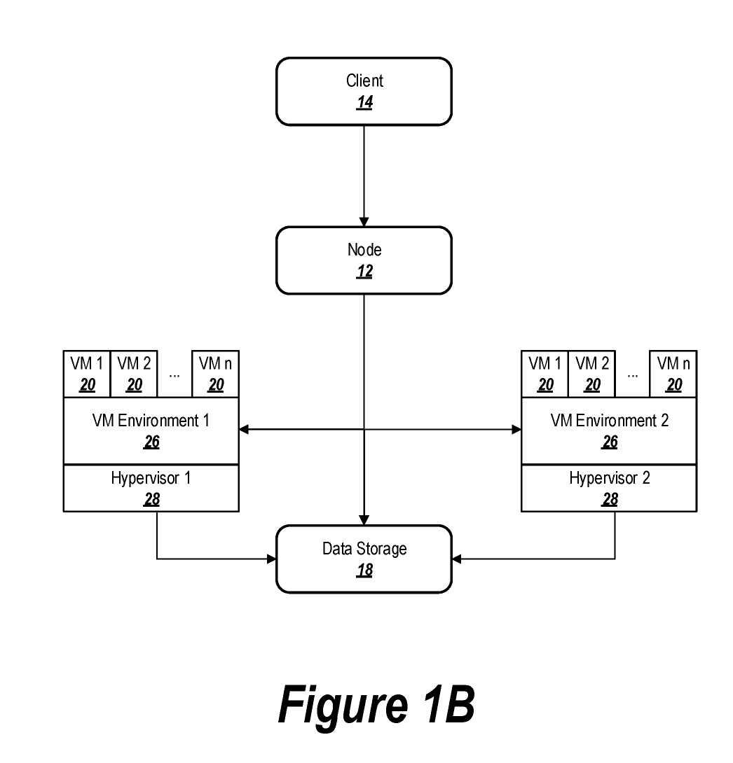

FIGS. 2A-4 provide a simplified overview of the concept behind the exemplary cache replacement techniques described herein.

In the system depicted in FIG. 2A, a client 14 requests data from a node 12, where the requests specify a read operation to be performed on a data object. In this example, the client 14 requests three data objects: a 0.9 MB data object, a 3.2 MB data object, and a 5.7 MB data object.

A cache 30 is maintained at the client 14 (although it is noted that the cache 30 may be located at any suitable device in the environment). As the data objects are retrieved from the node 12, the client 14 stores the data objects in the cache 30. If the same data item is needed in the future, the client 14 can retrieve the data object from the local cache 30, rather than reading the data remotely from the node 12.

When writing data to a cache, memory areas available to receive data may be allocated as blocks. The blocks may have a fixed size determined by the storage system (e.g., 1 MB). It is also possible to allocate blocks having different sizes. For example, some blocks may be allocated at 1 MB, some at 3 MB, some at 6 MB, etc.

If the storage system attempts to store a data object that is smaller than the block size, some of the block remains unused. On the other hand, if the storage system attempts to store a data object that is larger than the block size, the data object may be broken into pieces and more than one block may be used (although, if the data is not an exact multiple of the block size, some portion of at least one block may remain unused).

In the example depicted in FIG. 2, the cache 30 includes blocks of size 1 MB, 3 MB, and 6 MB. The client 14 reads a 0.9 MB data object, which can be stored in a 1 MB block with 0.1 MB of empty space left over. Similarly, the 5.7 MB data object can be stored in a 6 MB block, with 0.3 MB of empty space left over. On the other hand, the 3.2 MB data object is too large to fit into a single 3 MB block. This data object may be stored in a 6 MB block, with a relatively large space left over (2.8 MB of empty space), or may be split among multiple blocks (e.g., a 3 MB block and a 1 MB block, or four 1 MB blocks).

Thus, as the cache writes data to allocated blocks, some empty spaces remain on the disk. Moreover, when the cache is finished with certain storage space, it may be re-used (e.g., freed to be written over); the re-used locations may be in random locations in the memory. Accordingly, over time the available storage space becomes fragmented into multiple non-contiguous chunks. This fragmentation forces incoming cache requests to be split between available storage in different portions of the memory, which decreases cache access efficiency.

In some exemplary embodiments, as shown in FIG. 2B, the blocks of the cache 30 may be logically grouped into contiguous buckets 32-i, each bucket containing multiple contiguous blocks. When it comes time to free space in the cache, an entire bucket 32-i may be removed. In this way, larger contiguous areas are freed at once, which reduces fragmentation of the cache.

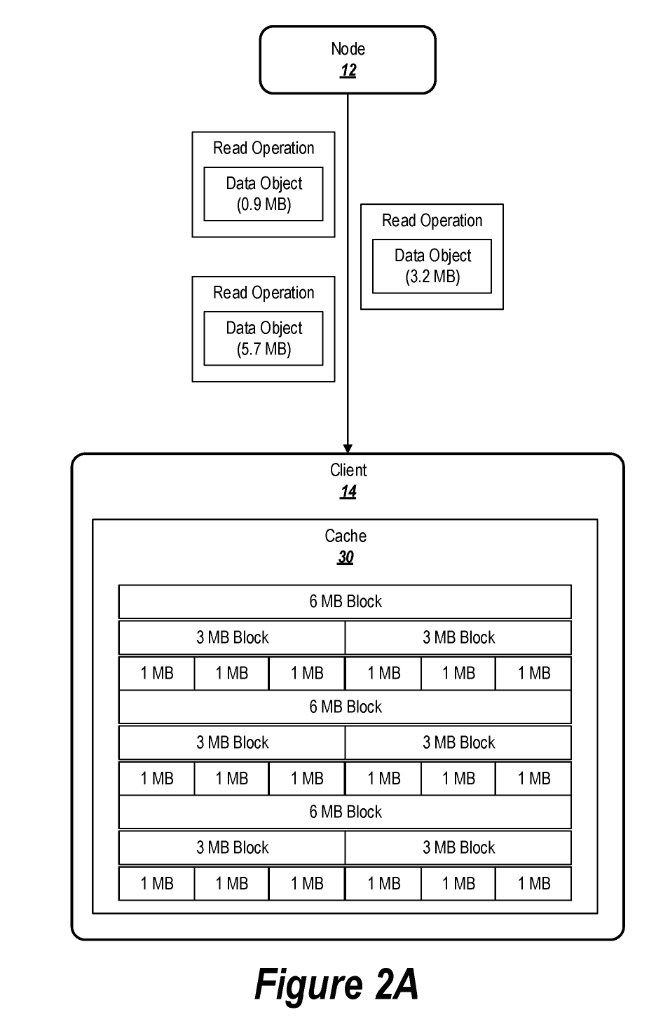

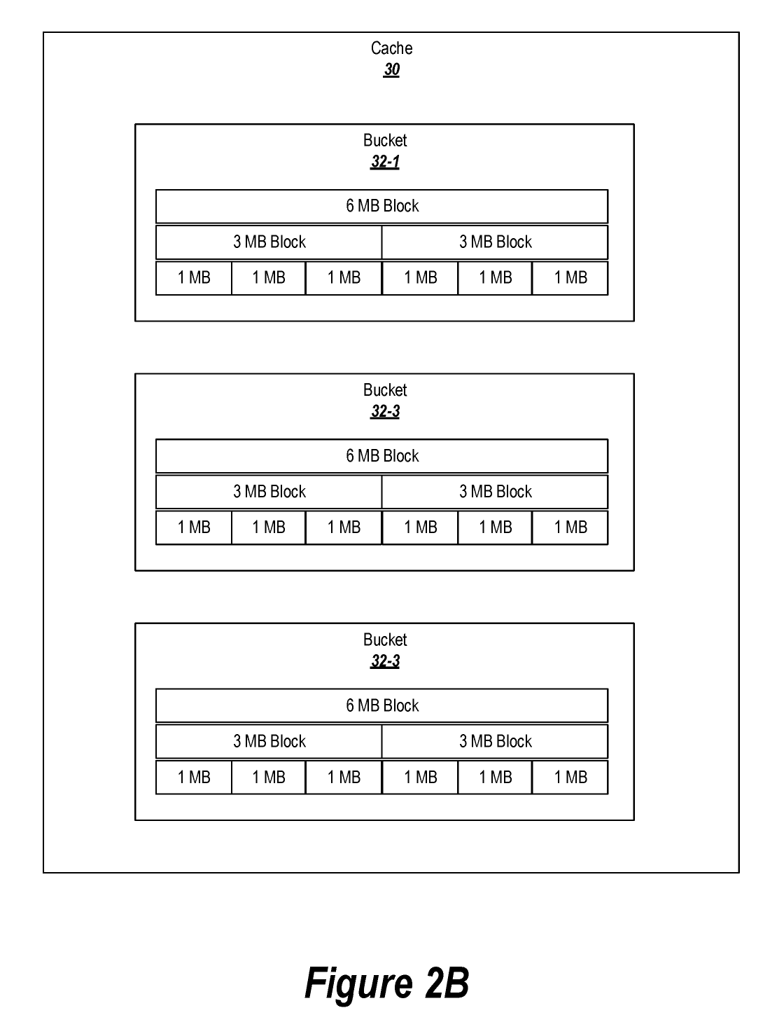

As shown in FIGS. 3A-4, the buckets 32-i may be scored and/or ranked based on data characteristics of data objects or blocks 34-i in the buckets. The bucket scores 36-i may be utilized to determine which buckets to remove.

The bucket scores may be calculated dynamically (e.g., whenever a request to free space in the cache is received) or may be calculated once or at regular intervals and stored in a predetermined location. For example, FIG. 3A depicts a situation in which the bucket scores 36-i are stored with each bucket 32-i in the cache 30. FIG. 3B depicts a situation in which the bucket scores 36-i are stored in a bucket database 38 separate from the cache 30. The bucket database 38 may include an entry 40-i for each bucket 36-i in the cache 30. Each entry 40-i may be associated with a key (an identifier 42-i for the bucket, in this case, which may be an address or memory offset of the bucket, a name of the bucket, a number associated with the bucket, etc.) and a value (the bucket score 36-i in this case).

Exemplary embodiments may employ scoring without necessarily sorting data blocks into buckets. In this case, an example of which is depicted in FIG. 4, a separate block database 42 may be employed, in which the value portion of the key/value pair represents the score 40-i for each individual block.

Next, exemplary methods for dividing a cache into buckets, scoring blocks and/or buckets, and selecting blocks and/or buckets for removal from the cache are described.

### Exemplary Methods, Mediums, and Systems

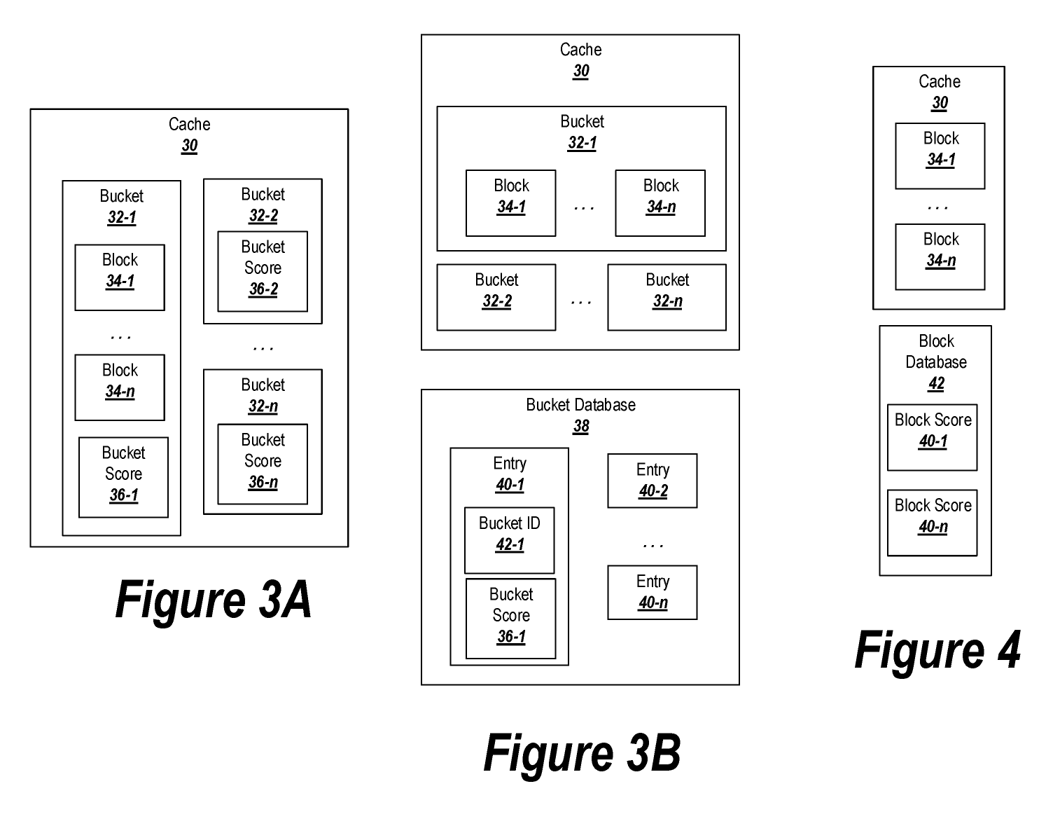

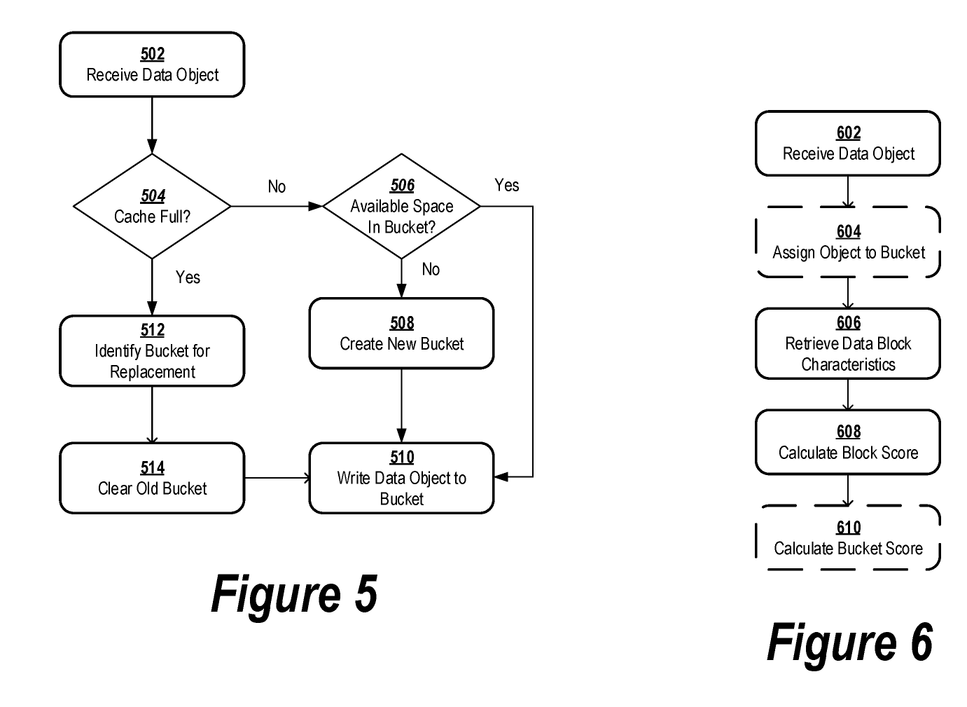

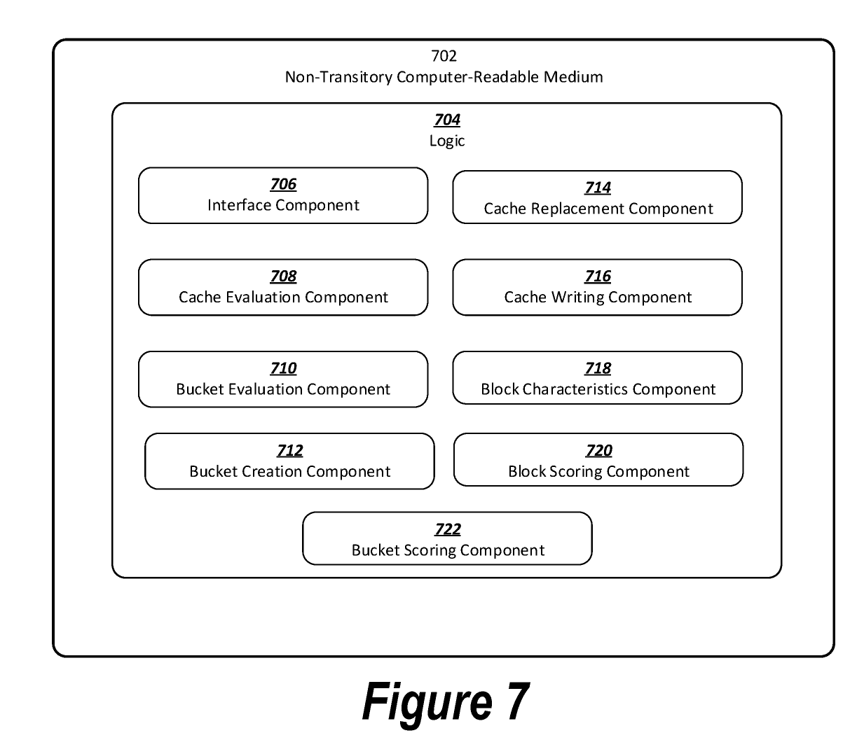

FIG. 5 depicts an exemplary method for managing a cache. FIG. 6 depicts an exemplary method for calculating block scores and/or bucket scores. The methods of FIGS. 5 and 6 may be implemented as computer-executable instructions stored on a non-transitory computer readable medium, as illustrated in FIG. 7.

With reference to FIG. 5, at block 502, a data object may be received for entry into the cache. The data object may be received as a result of a request to read the data object from a storage device, such as a cloud storage device. Block 502 may be performed by an interface component 706, as depicted in FIG. 7.

At block 504, the system may determine whether the cache is full. For example, the system may determine if there are any free blocks in the cache that are not occupied by data objects and, if so, whether there is sufficient free space in the free blocks to accommodate the data object.

Because data objects may be stored contiguously within a bucket, and because buckets may be stored contiguously in the cache, block 504 may entail checking the end of the last allocated bucket in the cache to determine whether there is sufficient space at the end of the bucket for the data block. In some cases, there may be free space at the end of a bucket, but the free space is insufficient to store a given data block. In that case, the system may move on to the next available bucket, leaving some free space at the end of a bucket before the beginning of the next bucket. Accordingly, step 504 may involve checking for free space at the end of the last allocated bucket and, if insufficient space is found, checking for free space at the end of preceding buckets. If insufficient space is found in the preceding bucket, the system may check the cache to determine whether free space exists that has not yet been allocated to any bucket.

In some embodiments, data objects can be split among multiple blocks. However, the system may maintain the entirety of a data object within a single bucket so that, when the bucket is recycled, the entire data object is recycled along with the budget (rather than having a portion of the data item continue to exist in an active bucket). In other embodiments, the system may allow the data object to be split between buckets, with the understanding that recycling at least one of the buckets would eliminate some of the data from the data object, while leaving the remainder of the data in the cache but unusable.

Block 504 may be performed by a cache evaluation component 708, as depicted in FIG. 7.

If the determination at block 504 is “no” (i.e., there is sufficient space in the cache for the new block), then processing may proceed to block 506. At block 506, the system may determine whether there is available space in an existing bucket. Because data objects may be stored contiguously within a bucket, and because buckets may be stored contiguously in the cache, the system may simply check the end of the last allocated bucket in the cache to determine whether there is sufficient space at the end of the bucket for the data block. As in block 504 above, the system may also check the end of preceding buckets in case free space exists at the end of these buckets.

Block 506 may be performed by a bucket evaluation component 710, as depicted in FIG. 7.

If the determination at block 506 is “no” (i.e., there is no available space in any existing bucket), then processing may proceed to block 508. Because it has already been determined at block 504 that the cache is not full, there is available space for a new bucket. At block 508, the system may either associate a predetermined number of blocks (or a number of blocks corresponding to a predetermined amount of memory) in the cache with a new bucket, or may allocate a number of new blocks in the cache and may assign the new blocks to a bucket. The bucket may be associated with an identifier that uniquely identifies the bucket among the other buckets in the cache.

Block 508 may be performed by a bucket creation component 712, as shown in FIG. 7.

After processing completes at block 508, or if the determination at block 506 is “yes” (i.e., there is sufficient space in an available bucket), then processing proceeds to block 510 and the system may write the data object to the bucket that has available space (either the partially empty old bucket or the newly allocated bucket). The system may select one or more blocks in the bucket of sufficient size to hold the data object, and may write the data object to the block(s), potentially splitting the data item between multiple blocks.

Block 510 may be performed by a cache writing component 716, as shown in FIG. 7.

Returning to block 504, if the determination at this block is “yes” (i.e., the cache is full), then some blocks in the cache must be recycled in order to write the new data object to the cache. Processing may proceed to block 512, where an existing bucket is identified for replacement. As described in more detail in FIG. 6, each bucket may be associated with a bucket score, which accounts for the data characteristics of the data objects and/or blocks stored in the bucket. The bucket with the lowest score may be selected for recycling. Alternatively or in addition, the buckets may be ranked based on their scores, and the bucket having the lowest rank may be selected for recycling.

The data objects stored in the buckets may be associated with fixed and/or variable characteristics. If the data objects are associated with variable characteristics that are permitted to change while the data object is stored in the cache, then a score for the data object/block may be calculated dynamically at the time that block 512 is carried out. The entire score for the data object/block (accounting for both the fixed and variable characteristics) may be carried out at this time, or only a score associated with the variable characteristics may be calculated, assuming that the fixed characteristic score has already been determined. The system may then rely on the dynamically-calculated variable score and the previously-calculated fixed score in determining a block score and, by extension, a bucket score.

Block 512 may be performed by a bucket evaluation component 710, as shown in FIG. 7.

Once a bucket is identified for replacement, processing may proceed to block 514 and the identified bucket may be cleared. This may involve deleting the data in the blocks associated with the bucket, or may simply involve freeing the blocks to be written over. For example, if the blocks are associated with entries in a log that tracks which data is stored in the buckets, the entries may be cleared so that new data can be written over the existing data in the block.

Block 514 may be performed by a cache replacement component 714, as shown in FIG. 7.

Processing may then proceed to block 510, and the data object may be written to the newly cleared bucket.

FIG. 6 depicts a process for calculating bucket scores (or block scores, if bucketing is not used in the cache). Blocks surrounded by dashed lines in FIG. 6 represent optional steps that may be performed if scoring is to be employed in conjunction with cache bucketing.

At block 602, the system may receive or access a data object. A data object may be a file or may be some other type of data structure to be stored in the cache. Block 602 may be performed by an interface component 706, as shown in FIG. 7.

At block 604, the data object may be assigned to a bucket. In some embodiments, the data object is assigned to the first or last existing bucket in the cache which has sufficient space for the data item. If no existing bucket has sufficient space for the data object, then a new bucket may be created. In some embodiments data objects may be evaluated to determine whether the data object is related to other data objects already stored in the cache. For example, if the data object was read at a time relatively close to another data object (temporal proximity), then it may be assumed that the data objects are related. Similarly, if the data object was retrieved from a location in a cloud storage device that is near a location of another data object in the cache, then the data objects may be considered related (spatial proximity). One of ordinary skill in the art will recognize that other techniques for determining whether two data objects are related (e.g., based on other types of proximity or other metrics) may also be employed. If two data objects are determined to be related, then the two data objects may be stored in the same bucket, if possible. Within a bucket, relatedness may also be used to store related blocks in close proximity to each other. In this way, if read requests for related data objects are submitted to the cache in succession, the data objects can be read from the cache (either directly in order, or at least relatively quickly).

Block 604 may be carried out by a cache writing component 716, as shown in FIG. 7.

At block 606, the system may retrieve characteristics of the data block (and/or a data object stored in the data block).

The characteristics may include fixed characteristics, which are fixed at the time that the data object is written to the cache. Examples of fixed characteristics include (E) whether the block containing the data object is marked for prioritized eviction, (P) whether the block is pinned to the cache, and (A) whether the block is cold archived in cloud storage, where E, P, and A represent scores or values (e.g., 0 for “no,” and 1 for “yes”) assigned to the characteristic.

The characteristics may include variable characteristics, which are allowed (or expected) to change as the data object resides in the cache. Examples of variable characteristics include (C) the creation time of the block storing the data object, (H) the most recent time that the block produced a deduplication hit, and (D) a deletion time of the block, where C, H, and D represent scores or values (e.g., specific times, or scores reflective of the recentness of the times in question) assigned to the characteristic.

Block 606 may be performed by a block characteristics component 718, as shown in FIG. 7.

At block 608, a score may be calculated for each block. An overall score may be calculated for the block account for the fixed and variable characteristics together, or separate scores may be calculated for the block's fixed and variable characteristics. The separate scores may then be combined to produce an overall score for the block. An example of this latter operation is provided below:

Calculate scores over fixed and variable characteristics:

Sᵥ=ƒ(C,D,H) where C,D,Hε [symbol] , Sᵥε[0,1)

S_{ƒ}=ƒ(E,P,A) where E,P,Aε[0,1), S_{f}ε[0,1)

Calculate a score for each block as a function of fixed score and variable score:

Sᵢ=ƒ(Sᵥ,S_{ƒ})

The functions ƒ(C, D, H) and ƒ(E, P, A) may be weighted in favor of, or against, any characteristic, depending on the application. For example, if the cache is used to cache items from cloud storage, the functions may be weighted in favor of characteristics that will improve the efficiency of the cache in a cloud storage context. Similarly, the function ƒ(Sᵥ, S_{ƒ}) may be weighted in favor of or against the fixed or the variable characteristics, depending on the application.

Block 608 may be performed by a block scoring component 720, as shown in FIG. 7.

At block 610, a score may be calculated for the buckets in the cache. Each bucket contains a number of blocks, and the score for the bucket maybe determined based on the score for the blocks contained in the bucket. Using the above-described block score examples, a rank of a bucket having n blocks may be represented, for example, as

$${\sum }_{i = 1}^{n} {S}_{i}$$

The buckets and/or blocks may optionally be ranked based on their respective scores. In this example, the higher the rank or score of a block/bucket, the lower the chances that the cache replacement algorithm will select the block/bucket for replacement.

Block 610 may be performed by a bucket scoring component 722, as shown in FIG. 7.

With reference to FIG. 7, an exemplary computing system may store, on a non-transitory computer-readable medium 702, logic 704 that, when executed, cause the computing system to perform the steps described above in connection with FIGS. 5 and 6. The logic 704 may include instructions stored on the medium 702, and may be implemented at least partially in hardware.

The logic 704 may include: an interface component 706 configured to execute instructions corresponding to steps 502 of FIG. 5 and 602 of FIG. 6 (the interface component 706 may include at least some hardware, such as a processor and/or network interface for receiving requests over a network); a cache evaluation component 708 configured to execute instructions corresponding to step 504 of FIG. 5; a bucket evaluation component 710 configured to execute instructions corresponding to steps 506 and 512 of FIG. 5; a bucket creation component 712 configured to execute instructions corresponding to step 508 of FIG. 5; a cache replacement component 714 configured to execute instructions corresponding to step 514 of FIG. 5; a cache writing component 716 configured to execute instructions corresponding to step 510 of FIG. 5 and step 604 of FIG. 6; a block characteristics component 718 configured to execute instructions corresponding to step 606 of FIG. 6; a block scoring component 720 configured to execute instructions corresponding to step 608 of FIG. 6; and a bucket scoring component 722 configured to execute instructions corresponding to step 610 of FIG. 6.

Some or all of the modules may be combined, such that a single module performs the several of the functions described above. Similarly, the functionality of one of the described modules may be split into multiple modules, or redistributed to other modules. The modules and related components may be stored on a single medium 702, or may be split between multiple mediums 702.

The embodiments described herein provide a number of advantages over traditional cache replacement algorithms. Because the cache replacement happens at the bucket level, cache fragmentation issues can be avoided. This leads to better cache utilization and efficiency. Moreover, the cache replacement becomes more intelligent, taking into consideration factors that impact both the cache and the data storage in a given context. For example, a cache replacement algorithm employed in connection with data stored in cloud storage can consider factors that affect deduplication efficiency and cloud usage costs. This allows the cloud storage and/or cache to be more efficient in providing increased deduplication and improved read/write throughput. These benefits may be achieved without the need to roll out new hardware, meaning that exemplary embodiments can be used to improve disk I/O performance even on an aged system.

### Computer-Related Embodiments

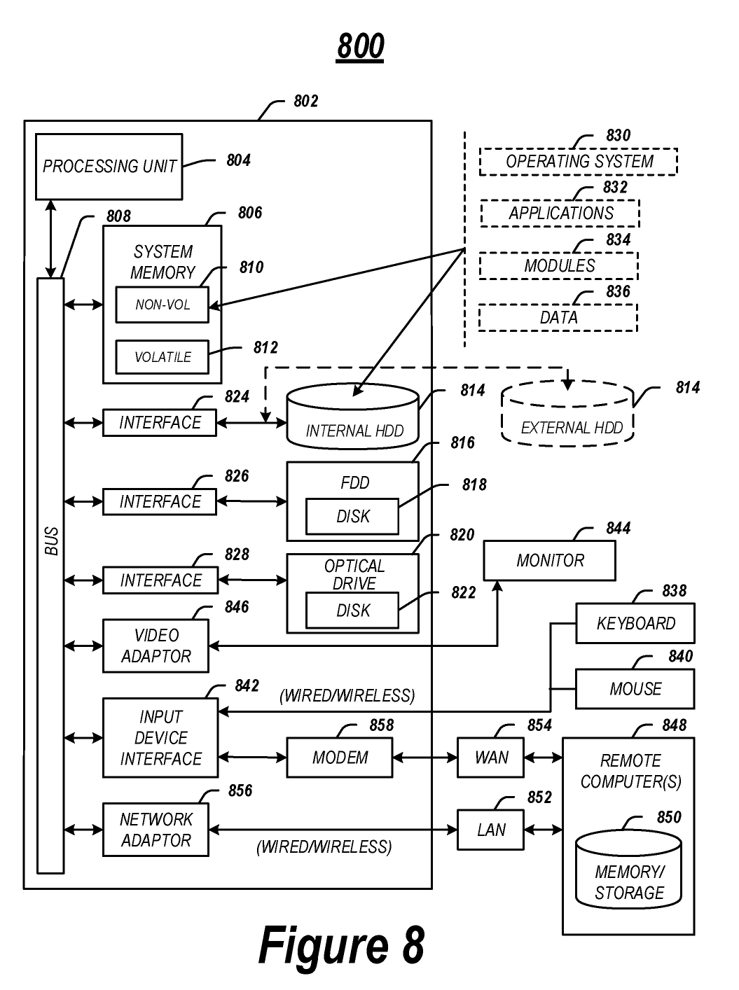

The above-described method may be embodied as instructions on a computer readable medium or as part of a computing architecture. FIG. 8 illustrates an embodiment of an exemplary computing architecture 800 suitable for implementing various embodiments as previously described. In one embodiment, the computing architecture 800 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 800 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi processor architectures may also be employed as the processing unit 804.

The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures. Interface adapters may connect to the system bus 808 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 800 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal (or external) hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 694 interface technologies.

The drives may include traditional hard drives (HDDs) and/or flash-based drives. The drives may be all traditional HDDs, all flash drives, or a combination of HDDs and flash drives.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. In one embodiment, the one or more application programs 832, other program modules 834, and program data 836 can include, for example, the various applications and/or components of the system 30.

A user can enter commands and information into the computer 802 through one or more wire/wireless input devices, for example, a keyboard 838 and a pointing device, such as a mouse 840. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 504 through an input device interface 842 that is coupled to the system bus 808, but can be connected by other interfaces such as a parallel port, IEEE 694 serial port, a game port, a USB port, an IR interface, and so forth.

A monitor 844 or other type of display device is also connected to the system bus 808 via an interface, such as a video adaptor 846. The monitor 844 may be internal or external to the computer 802. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.13 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.13x (a, b, g, n, etc.) to provide secure, reliable, fast wireless connectivity. A Wi-Fi network can be used to connect computers to each other, to the Internet, and to wire networks (which use IEEE 802.3-related media and functions).

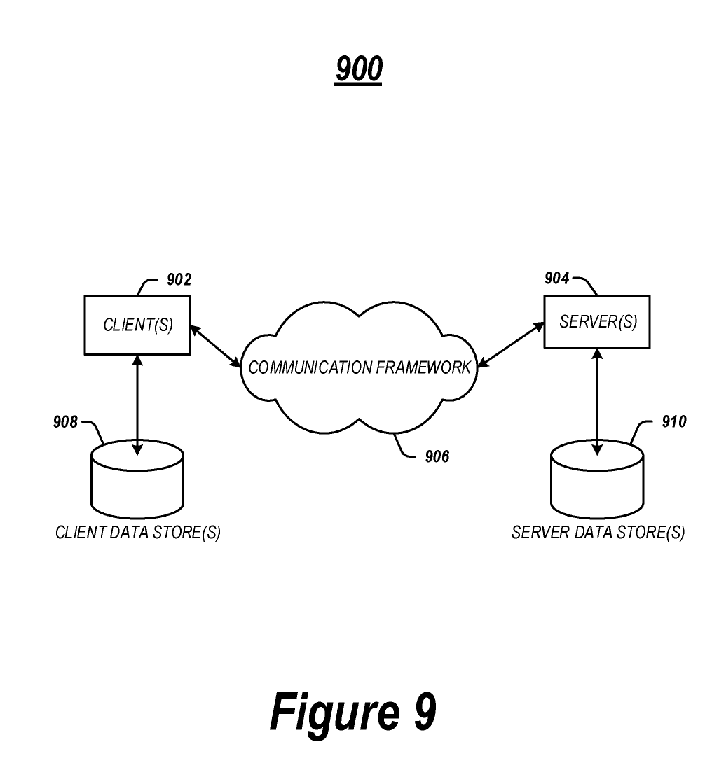

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, power supplies, and so forth. The embodiments, however, are not limited to implementation by the communications architecture 900.

As shown in FIG. 9, the communications architecture 900 comprises includes one or more clients 902 and servers 904. The clients 902 may implement the client device 14 shown in FIG. 1A. The servers 604 may implement the server device 104 shown in FIG. 1A. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques and protocols. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 906 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 902 and the servers 904. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

### General Notes on Terminology

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system comprising:
an interface component, at least a portion of which is implemented in hardware, configured to receive a request to free space in a cache, the cache divided into data blocks, the data blocks comprising a first plurality of data blocks grouped into a first bucket and a second plurality of data blocks grouped into a second bucket;
a bucket evaluation component, at least a portion of which is implemented in hardware, configured to select at least the first bucket for deletion from the cache; and
a cache replacement component, at least a portion of which is implemented in hardware, configured to remove the first plurality of data blocks in response to the request to free space in the cache.

2. The system of claim 1, wherein the first bucket and the second bucket each represent contiguous data blocks in the cache.

3. The system of claim 1, wherein the interface component is configured to receive a request to write a data object to a block of the cache, and further comprising:
a cache evaluation component configured to identify that the cache is full, and to request that the space in the cache be freed in response to identifying that the cache is full.

4. The system of claim 1, wherein the interface component is configured receiving a request to write a data object to a block of the cache, and further comprising:
a cache writing component configured to write the data block to the cache
assigning the data block to the first bucket or the second bucket

5. The system of claim 1, further comprising a bucket scoring component configured to calculate a first bucket score for the first bucket and a second bucket score for the second bucket;
wherein the bucket evaluation component is configured to compare the first bucket score to the second bucket score and selecting the first bucket for deletion based on the comparing.

6. The system of 5, further comprising a block scoring component configured to calculate a block score for each of the blocks in the first bucket, wherein the first bucket score is calculated based on the calculated block scores.

7. The system of claim 6, wherein the block scores are calculated based on at least one fixed characteristic of a block that is fixed at a time that the data block is written to the cache and at least one variable characteristic of a data block that is permitted to vary while the block is stored in the cache.

8. A non-transitory computer readable medium storing instructions that, when executed by one or more processors, cause the one or more processors to:
receive a request to free space in a cache, the cache divided into data blocks, the data blocks comprising a first plurality of data blocks grouped into a first bucket and a second plurality of data blocks grouped into a second bucket;
select at least the first bucket for deletion from the cache; and
remove the first plurality of data blocks in response to the request to free space in the cache.

9. The medium of claim 8, wherein the first bucket and the second bucket each represent contiguous data blocks in the cache.

10. The medium of claim 8, further storing instructions to:
receive a request to write a data object to a block of the cache, and;
identify that the cache is full, and to request that the space in the cache be freed in response to identifying that the cache is full.

11. The medium of claim 8, further storing instructions to:
receive a request to write a data object to a block of the cache;
write the data block to the cache; and
assign the data block to the first bucket or the second bucket.

12. The medium of claim 8, further storing instructions to:
calculate a first bucket score for the first bucket and a second bucket score for the second bucket; and
compare the first bucket score to the second bucket score and select the first bucket for deletion based on the comparing.

13. The medium of claim 12, further storing instructions to calculate a block score for each of the blocks in the first bucket, wherein the first bucket score is calculated based on the calculated block scores.

14. The medium of claim 13, wherein the block scores are calculated based on at least one fixed characteristic of a block that is fixed at a time that the data block is written to the cache and at least one variable characteristic of a data block that is permitted to vary while the block is stored in the cache.

15. A method comprising:
receiving a request to free space in a cache, the cache storing data blocks, the data blocks comprising a first plurality of data blocks grouped into a first bucket and a second plurality of data blocks grouped into a second bucket;
selecting at least the first bucket for deletion from the cache; and
removing the first plurality of data blocks in response to the request to free space in the cache.

16. The method of claim 15, wherein the first bucket and the second bucket each represent contiguous data blocks in the cache.

17. The method of claim 15, further comprising:
receiving a request to write a data object to a block of the cache;
writing the data block to the cache; and
assigning the data block to the first bucket or the second bucket.

18. The method of claim 15, further comprising:
calculating a first bucket score for the first bucket and a second bucket score for the second bucket; and
comparing the first bucket score to the second bucket score and select the first bucket for deletion based on the comparing.

19. The method of claim 18, further comprising calculating a block score for each of the blocks in the first bucket, wherein the first bucket score is calculated based on the calculated block scores.

20. The method of claim 19, wherein the block scores are calculated based on at least one fixed characteristic of a block that is fixed at a time that the data block is written to the cache and at least one variable characteristic of a data block that is permitted to vary while the block is stored in the cache.
